(19) United States
(12) Patent Application Publication
(10) Pub. No.: US 2016/0336034 A1
(43) Pub. Date: Nov. 17, 2016

(54) OPTICAL INFORMATION REPRODUCING DEVICE AND REFERENCE BEAM ADJUSTING METHOD

(71) Applicant: Hitachi-LG Data Storage, Inc., Tokyo (JP)

(72) Inventors: Takeshi IMAI, Tokyo (JP); Kouichirou NISHIMURA, Tokyo (JP); Masanobu SHIGAKI, Tokyo (JP)

(73) Assignee: Hitachi-LG Data Storage, Inc., Tokyo (JP)

(21) Appl. No.: 15/151,607

(22) Filed: May 11, 2016

(30) Foreign Application Priority Data
May 12, 2015 (JP) 2015-097686

(51) Int. Cl. G11B 7/08; G11B 7/13; G11B 7/126; G11B 7/0065; G11B 7/007

(52) U.S. Cl. CPC G11B 7/083; G11B 7/0065; G11B 7/00772; G11B 7/126; G11B 7/13

(57) ABSTRACT

A reference beam adjusting method for reproducing information recorded on an optical information recording medium by utilizing interference of a signal beam with a reference beam includes a step of changing the wavelength of the reference beam; a step of changing the angle of the reference beam to the optical information recording medium; a step of detecting a brightness distribution of the reproduction image from the optical information recording medium; a step of calculating a gravity center dispersion in the brightness distribution of the reproduction image; and a step of controlling the angle and wavelength of the reference beam based on the gravity center dispersion.

### BACKGROUND OF THE INVENTION

1. Field of the Invention

The present invention relates to an optical information reproducing device that reproduces information recorded on an optical information recording medium by utilizing interference of a signal beam with a reference beam, and also relates to a reference beam adjusting method for the reproducing device.

2. Description of the Related Art

Hologram recording technology is a technology for overlapping a signal beam having information of page data modulated two-dimensionally by a spatial light modulator to a reference beam in an optical recording medium, generating refractive index modulation in the recording medium by a fringe pattern generated at that time, and recording the information on the recording medium. In reproducing the information, when the optical information recording medium is irradiated with the reference beam used at the time of recording, a hologram recorded on the recording medium acts like a diffraction grating to generate diffracted light. The diffracted light is reproduced as the same light as the recorded signal beam, including phase information. The reproduced signal beam is detected at a high speed two-dimensionally using a light detector such as a CMOS or a CCD. As such, the hologram recording technology enables two-dimensional information to be recorded/reproduced on the optical recording medium by one hologram and further enables a plurality of page data to be overwritten to a certain place of the optical recording medium, so that large-capacity and high-speed information can be recorded/reproduced.

In the reproduction of the hologram, if the recording medium is contacted/expanded according to a temperature, the angle and interval of a grating recorded as the diffraction grating changes, so that a signal quality of the reproduction light is deteriorated. In order to compensate for the deterioration in the signal quality, it is necessary to adjust the incidence angle and wavelength of the reference beam radiated to the recording medium.

Japanese Patent Application Laid-Open No. 2015-56194 (hereafter as “Patent Literature 1”) is regarded as background art in the present technical field. In Patent Literature 1, there is disclosed a construction including a light source that emits light toward an optical information recording medium, a light source control unit that controls the wavelength of the light emitted from the light source, a reference beam angle control unit that controls the incidence angle of the reference beam to the optical information recording medium, a light detector that detects a reproduction image from the optical information recording medium or a brightness distribution of the reproduction image, a reproduction image processing unit that detects a bright line of the production image on the basis of a detection result of the light detector and outputs a detection result of the bright line, and a control unit that controls the wavelength of the light emitted from the light source through the light source control unit on the basis of an output of the reproduction image processing unit and controls the incidence angle of the reference beam through the reference beam angle control unit.

In Patent Literature 1, detection is made for an bright line-to-line angle that the bright line of the reproduction image where the incidence angle of the reference beam and the wavelength of the light source are optimum, makes with the bright line of the detected production image or for a bright line position error being the differences between the positions of the respective bright lines, and the incidence angle of the reference beam and the wavelength of the light source are controlled based on the bright line-to-line angle or the bright line position error. However, the bright line portion is uneven in density and also obscure in light and shade, wherein no consideration is taken into a possibility that a deviation from its appropriate adjusting target occurs where the brightness of the bright line portion is utilized as it is.

Accordingly, it is an object of the present invention to provide an adjusting index being difficult to be influenced by the unevenness in brightness and the like at a bright line portion for speedily adjusting the incident angle of a reference beam and the wavelength of a light source and thereby to provide an optical information reproducing device and a reference beam adjusting method capable of adjusting the angle of the reference beam and the wavelength of the reference beam in a short period of time.

### SUMMARY OF THE INVENTION

In order to achieve the aforementioned object, a construction described in, for example, one aspect of the present invention is taken. The present application covers a plurality of means for addressing the aforementioned object and, as one example cited, is directed to a reference beam adjusting method for reproducing information recorded on an optical information recording medium by utilizing interference of a signal beam with a reference beam, wherein the method includes a step of changing the wavelength of the reference beam, a step of changing the angle of the reference beam to the optical information recording medium, a step of detecting a brightness distribution of a reproduction image from the optical information recording medium, a step of calculating a gravity center dispersion in the brightness distribution of the reproduction image, and a step of controlling the angle and wavelength of the reference beam based on the gravity center dispersion.

According to one aspect of the present invention, it is possible to provide an adjusting index which is used for speedily adjusting the incidence angle of the reference beam and the wavelength of the right source and which is difficult to be influenced by the unevenness in brightness and the like at a bright line portion, and thereby to provide an optical information reproducing device and a reference beam adjusting method capable of adjusting the angle of the reference beam and the wavelength of the reference beam in a short period of time.

### BRIEF DESCRIPTION OF THE DRAWINGS

FIG. 1 is a diagram illustrating a recording operation in a hologram recording device;

FIG. 2 is a diagram illustrating a reproduction operation in the hologram recording device;

FIG. 3(A) to FIG. 3(C) are schematic illustrations showing reproduction images on a light detector in a first embodiment;

FIG. 4(A) to FIG. 4(D) are illustrations for illustrating an adjusting index that adjusts the angle and wavelength of a reference beam in the first embodiment;

FIG. 5 is a flowchart for obtaining an adjusting index value in the first embodiment;

FIG. 6(A) and FIG. 6(B) are schematic diagrams respectively illustrating adjusting index value and whole brightness measured with changes of wavelength and reference beam angle;

FIG. 7 is a graph plotting the relation between reference beam angle, whole brightness and adjusting index value on a certain wavelength in the first embodiment;

FIG. 8 is a graph plotting the relation between wavelength and minimum adjusting index value with changes of reference beam angle in the first embodiment;

FIG. 9(A) and FIG. 9(B) are diagrams for illustrating the necessity to decrease the number of adjusting index measurements in a second embodiment;

FIG. 10(A) and FIG. 10(B) are diagrams for illustrating a method for reducing the number of adjusting index measurements in a second embodiment;

FIG. 11 is an illustration for illustrating the case wherein a surface reflection from an optical information recording medium is seen as the brightness distribution of a reproduction image on an light detector in a third embodiment; and

FIG. 12 is a processing flowchart for obtaining the brightness distribution capable of obviating the influence of the surface reflection from the optical information recording medium in the third embodiment.

### DETAILED DESCRIPTION OF THE PREFERRED EMBODIMENTS

Hereinafter, embodiments of the present invention will be described with reference to the accompanying drawings.

### First Embodiment

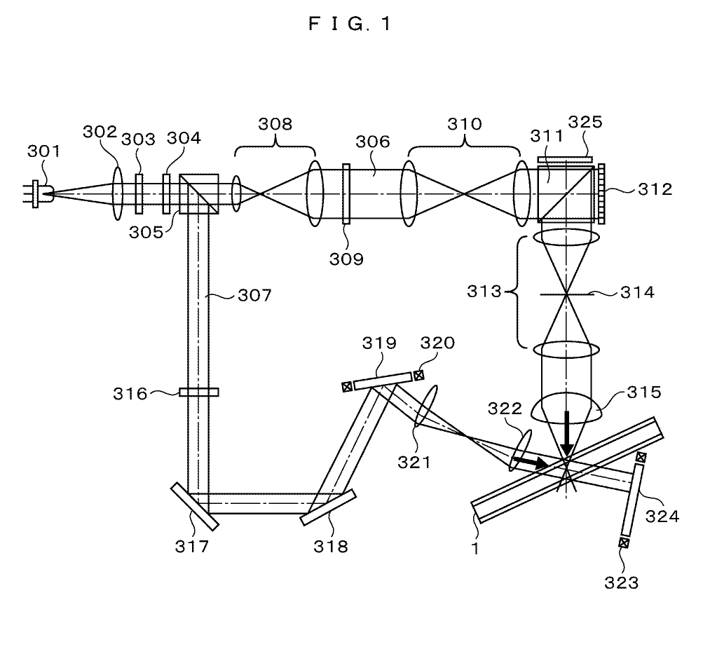

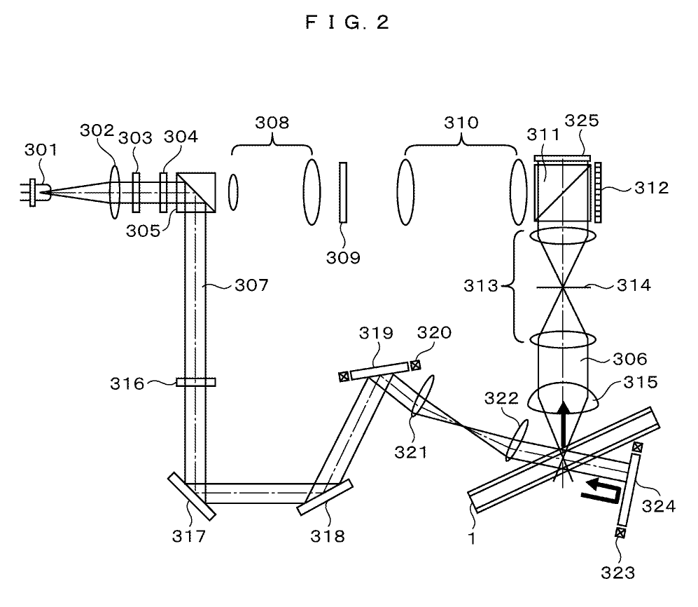

FIG. 1 and FIG. 2 show one example of a basic configuration of a hologram recording/reproducing device. A recording principle will be described with reference to FIG. 1.

In FIG. 1, a light beam emitted from a light source 301 passes through a collimate lens 302 and is incident on a shutter 303. When the shutter 303 is opened, the light beam passes through the shutter 303, and a polarization direction of the light beam is controlled by an optical element 304 configured with, for example, a half wavelength plate so that a light amount ratio of p polarized light and s polarized light becomes a desired ratio. Then, the light beam is incident on a polarization beam splitter (PBS) prism 305.

The light beam having passed through the PBS prism 305 functions as a signal beam 306, and a light beam diameter thereof is increased by a beam expander 308. Then, the light beam passes through a phase mask 309, a relay lens 310 and a PBS prism 311 and is incident on a spatial light modulator 312.

The signal beam to which information has been added by the spatial light modulator 312 is reflected on the PBS prism 311 and is propagated through a relay lens 313 and a spatial filter 314. Then, the signal beam is condensed on an optical information recording medium 1 by an objective lens 315.

Meanwhile, the light beam having reflected on the PBS prism 305 functions as a reference beam 307, and a polarization direction thereof is set by a polarization direction converting element 316 to a Predetermined polarization direction according to a recording mode or a reproduction mode. Then, the light beam is reflected on mirrors 317 and 318 and is incident on a galvano-mirror 319. The galvano-mirror 319 is adjustable in angle by an actuator 320 and thus, is able to set to a desired angle the incidence angle at which the reference beam after passing through a lens 321 and a lens 322 is incident on the optical information recording medium 1.

Like this, the signal beam and the reference beam are made to be incident to overlap each other in the optical information recording medium 1 to form a fringe pattern in the recording medium, and information is recorded by writing the pattern to the recording medium.

In addition, since the angle at which the reference beam is incident on the optical information recording medium 1 can be changed by the galvano-mirror 319, angle multiple recording is enabled. Here, an angle of an angle multiple direction is set as a bragg direction angle, and an angle in a direction approximately normal to the bragg direction angle is set as a pitch direction angle. The bragg direction angle will hereafter be simplified to be referred to as a reference beam angle. Further, holograms corresponding to individual reference beam angles in holograms recorded by changing the reference beam angle in the same region will be called pages, and a set of pages subjected to angle multiple recording in the same region will be called a book.

Next, a reproduction principle will be described with reference to FIG. 2. In reproducing recorded information, as mentioned earlier, the reference beam is incident on the optical information recording medium 1, and the light beam having passed through the optical information recording medium 1 is reflected by a galvano-mirror 324 the angle of which can be adjusted by an actuator 323, so that a reproduction reference beam is generated.

A reproduction light reproduced by the reproduction reference beam is propagated through the objective lens 315, the relay lens 313 and the spatial filter 314. Then, the reproduction light passes through the PBS prism 311 and is incident on a light detector 325. The signal detected by the light detector 325 can be reproduced as a recorded signal by a signal processing unit, not shown. In addition, an output of the light detector is also inputted to a reproduction image processing unit, not shown, wherein a processing result corresponding to the reproduction image on the light detector or a brightness distribution of the reproduction image is outputted to a controller unit, not shown. The controller unit controls the whole of the optical information recording/reproducing device. As the light detector 325, there can be used an image pickup element such as a CMOS image sensor or a CCD image sensor. However, any element can be used if the same is of the property capable of reproducing page data.

As mentioned earlier, in reproduction of the hologram, if the optical information recording medium 1 is contracted/expanded according to the temperature, a quality of the reproduced signal beam is deteriorated. In addition, in recording technology using an angle multiple principle of holography, an allowance error with respect to a deviation of a reference beam angle is extremely small, and therefore, a deviation in angle of the reference beam irradiated to the optical information recording medium 1 due to errors in mounting a mechanism such as a disk rotation motor or a pickup greatly affects the quality of the signal beam. For this reason, at the time of reproduction, it is necessary to adjust the angle and wavelength of the reference beam irradiated to the recording medium in correspondence to a deviation of the temperature from the temperature at the time of recording of the optical information recording medium as well as to errors in mounting a mechanism for each device. Incidentally, although not shown, there is taken a construction that adjusts the wavelength of the light source through a light source control unit.

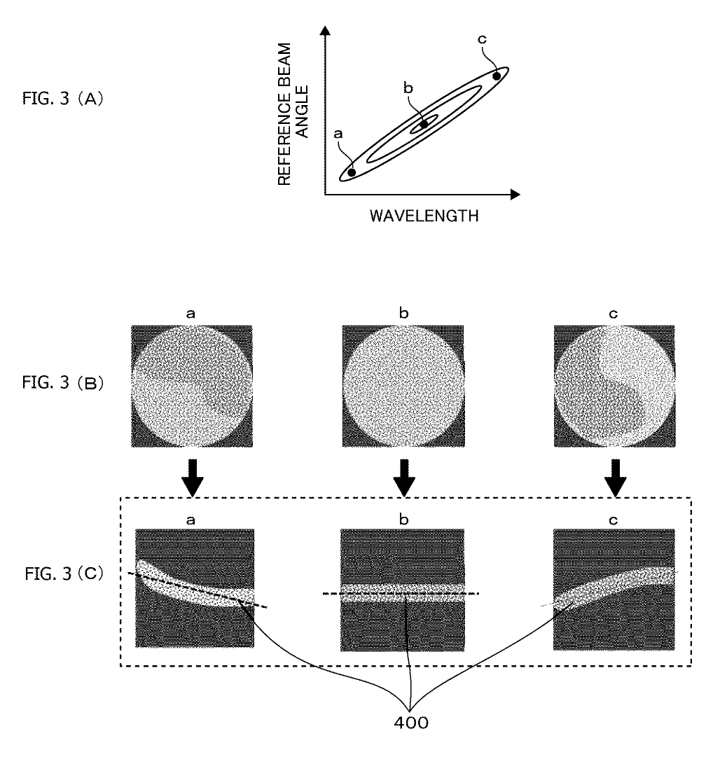

Next, description will be made regarding the characteristic of the reproduction image of hologram which the present embodiment takes as the premise. FIG. 3(A) to FIG. 3(C) are schematic diagrams showing reproduction images on the light detector 325. These show the states in each of which dots constituting light and shade depending on recorded data being a reproduction object gather in a circular shape. Where the combination between the reference beam angle and the wavelength is optimum as it is to be, the production image can be reproduced with itself being even in brightness and distinct in light and shade to become FIG. 3(B)b. FIG. 3(B)a and FIG. 3(B)c show the states wherein a deviation arises in the combination between the reference beam angle and the wavelength, and thus, the reproduction image becomes uneven in brightness and indistinct in light and shade. FIG. 3(A) is a schematic diagram representing one example of the relation between the brightness of the reproduction image, the reference beam angle and the reference beam wavelength in the form of contour lines. FIG. 3(A) represents that the reproduction image is higher in brightness if it belongs to an inner one of the contour lines. Accordingly, it can be grasped that an optimum combination exists between the reference beam angle and the reference beam wavelength in making the brightness of the reproduction image maximum. The states in FIG. 3(B) a, b and c respectively correspond to the combinations shown in FIG. 3(A) a, b, and c between the reference beam angle and the reference beam wavelength. Further, when a pitch direction angle being the angle in the direction approximately normal to the reference beam angle is shifted in the states shown in FIG. 3(B) a, b and c, portions being high in brightness become linear as shown in FIG. 3(C) a, b and c, respectively. The linear portions 400 being high in brightness will hereafter be referred to as bright lines. A relation exists that the bright line becomes horizontal when the combination between the reference beam angle and the wavelength is in an optimum state for reproduction. In the present embodiment, this relation is utilized to make the bright line horizontal, so that a reference beam angle and a wavelength for the optimum image can be sought.

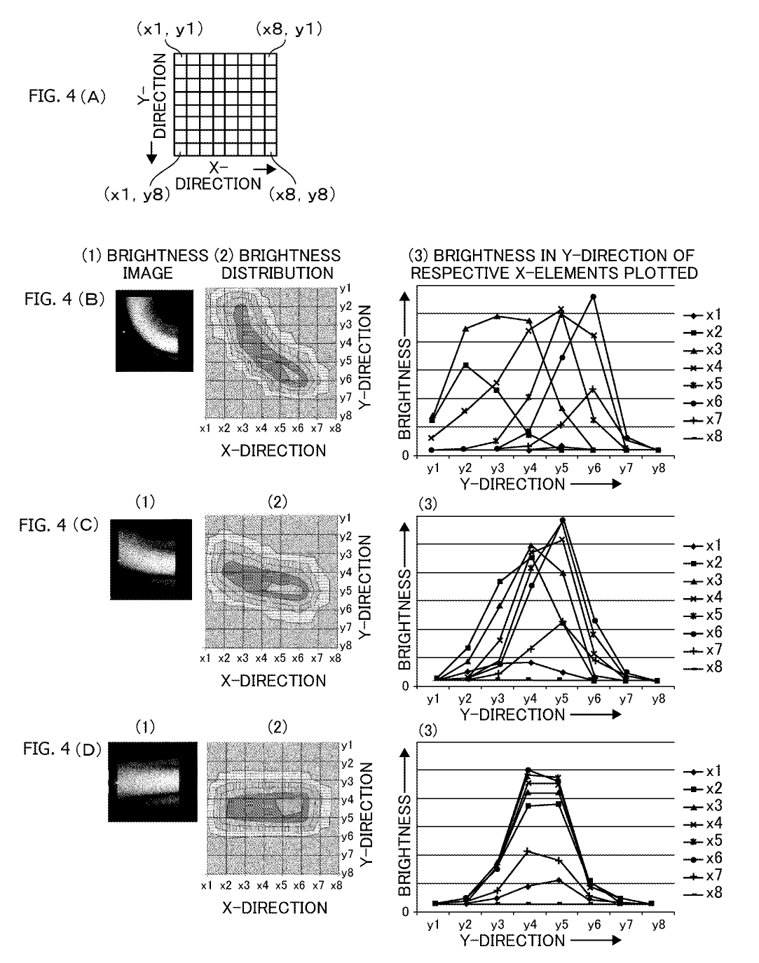

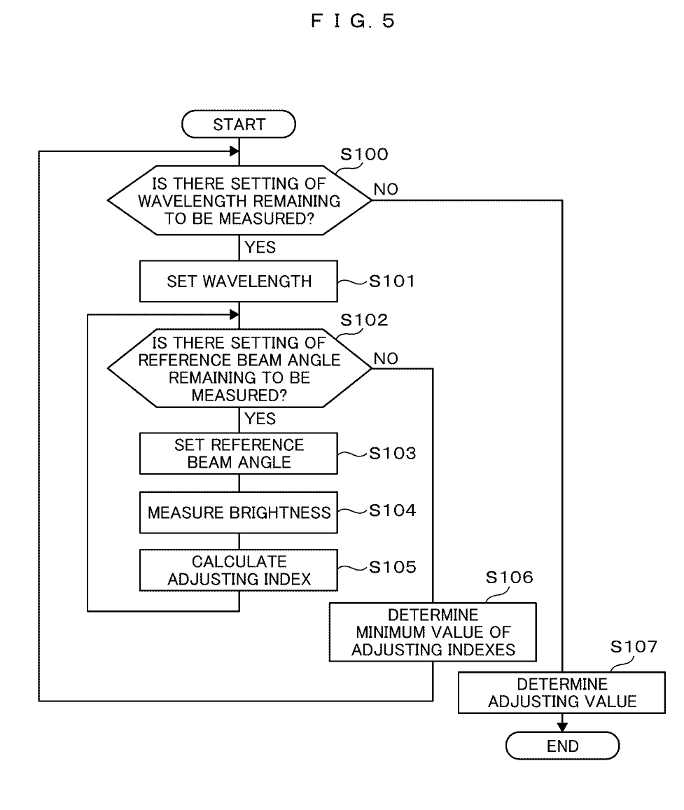

In the present embodiment, the degree at which the bright line inclines relative to the horizontal is converted into a numeral, which is taken as an adjusting index for adjusting the reference beam angle and the wavelength. A specific method therefor will be described with reference to FIG. 4. As shown in FIG. 4(A), first of all, there is utilized a distribution state in brightness of a reproduction image on the light detector whose detection surface is partitioned into small regions. For example, description will be made taking small regions made by 8×8 divisions in X and Y directions. When the brightness image of a production image on the light detector is such that the bright line steeply inclines relative to the horizontal as shown in FIG. 4(B)(1), the brightness plotted on the basis of the 8×8 small regions becomes as shown in FIG. 4(B)(2). FIG. 4(B)(2) is a schematic diagram illustrating the brightness of the reproduction image in the form of contour lines. The diagram represents that the reproduction image encircled by an inner one of the contour lines is higher in brightness than that within an outer one of the contour lines. Then, FIG. 4(B)(3) is a diagram plotting the Y-direction brightness for each of X-direction elements. From FIG. 4(B)(3), it can be grasped that the brightness at the respective X-elements in the case of FIG. 4(B) (1) disperses in the Y-direction. FIG. 4(C)(1)-(3) show the case that the inclination of the bright line is gentler than that in the case of FIG. 4(B)(1)-(3), wherein FIG. 4(C)(1) shows the brightness image of the reproduction image, FIG. 4(C)(2) shows the brightness distribution and FIG. 4(C)(3)shows the diagram plotting the Y-direction brightness for the respective X-elements. From FIG. 4(C)(3), it can be grasped that in the case of FIG. 4(C), the dispersions in the Y-direction of the brightness of the respective X-elements have become smaller in comparison with the case of FIG. 4(B). Then, FIG. 4(D)(1)-(3) respectively show the brightness image of the reproduction image, the brightness dispersion and the diagram plotting the Y-direction brightness for the respective X-elements in the case where the bright line is approximately horizontal. From FIG. 4(D)(3), it can be grasped that in the case of FIG. 4(D), lines made by plotting the brightness of the respective X-elements in the Y-direction overlap one another for the most parts and nearly, do not disperse. Like this, as the bright line comes close to the horizontal, the lines made by plotting overlap one another and decrease in dispersion. On the basis of this relation, gravity centers in the brightness distributions on each line region in the Y-direction for the respective X-direction elements are calculated as an index for use in adjustment, and the dispersion of the gravity centers in the Y-direction is taken as an adjusting index. Usually, the calculation for the dispersion uses a mean value of all of the gravity centers. In the present adjustment, however, because it is the object to make the bright line horizontal at the center of the display screen, a value that enables the center of the image to come to the gravity center is taken instead of the mean value. That is, the adjusting index is calculated by the following expression (1).

Adjusting Index=Σₙ₌₁⁸(Value Placing Image Center at Gravity center−Gravity Center n)² [Expression 1]

That is, in the present embodiment, since eight divisions are made in the Y-direction, 4 and 5 being the middle points in the Y-direction are set as a target value, and thus, the adjusting index is taken as a value that enables the center of the image to come to the gravity center. Further, the gravity center of the brightness distribution in each line region in the Y-direction is set as a value which is calculated by weighting the brightness value in each of the small regions on each line in the Y-direction in correspondence to its position in the Y-direction and by dividing a total value of the weighted brightness, which results from the addition of the respective weighted brightness values, by a total value of brightness in the respective small regions on each line in the Y-direction. Incidentally, the foregoing calculation is one example, instead of which various kinds of modifications may be conceived of. For example, as the value that enables the image center to come to the gravity center, the gravity center may be calculated by not taking “4 and 5” mentioned above but taking the middle point in the Y-direction as “0”, by using absolute values instead of squared values, or by taking the average of one n-th. That is, as shown in FIG. 4(D) (3), it is suffice to take as the adjusting index the level at which the brightness distributions in the Y-direction of the respective X-direction elements overlap one another, and thus, it does not matter how the calculation is performed specifically. By so adjusting that the adjusting index set in this way becomes smaller, in other words, the overlap level rises to decrease the dispersion, it is possible to adjust the reference beam angle and the wavelength to those optimum.

FIG. 5 shows a flowchart for obtaining the adjusting index value in the present embodiment. As shown in FIG. 5, a wavelength setting, a reference beam angle setting and a brightness measurement are repetitively carried out to seek a combination between the wavelength and the reference beam angle in which combination the calculated adjusting index becomes minimum (the bright line becomes horizontal). More specifically, in FIG. 5, a certain wavelength is set at S101, a reference beam angle is set at S103, a brightness measurement is carried out at S104, an adjusting index is calculated at S105, and these steps are repeated, so that a combination between a wavelength and a reference beam angle is determined in which combination an adjusting index that is calculated at the reference beam angle relative to a certain wavelength becomes minimum (the bright line becomes horizontal) at S106. These processing like such are repeated for a number of predetermined wavelengths. Subsequently, at step S107, the minimum value is chosen from the minimum index values detected at S106 on the respective wavelengths.

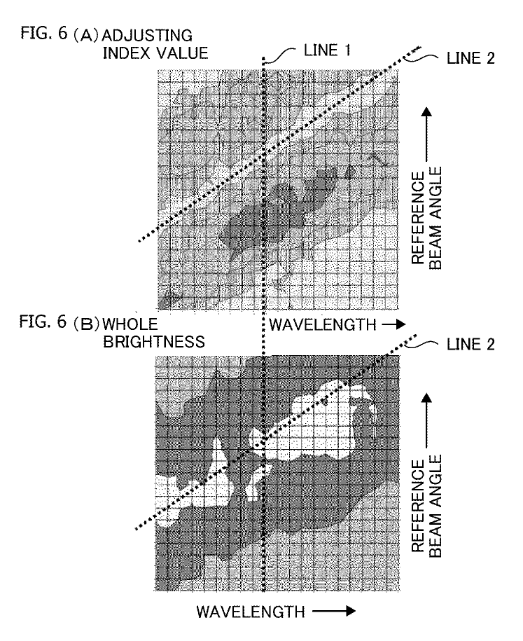

FIG. 6(A) and FIG. 6(B) are schematic diagrams respectively representing the adjusting index value and the whole brightness which are measured with changes of the wavelength and the reference beam angle. FIG. 6(A) illustrates adjusting index values in the form of contour lines in the schematic diagram, wherein a white part along a line 2 is a part having small adjusting index values. Further, as the aforementioned FIG. 3(A) does, FIG. 6(B) illustrates the relation between the brightness of a reproduction image, the reference beam angle and the reference beam wavelength in the form of contour lines in the schematic diagram, wherein it is represented that the brightness of the reproduction image is higher inside an inner contour line than that in an outer contour line. That is, a part along the line 2 is the part where the brightness is high.

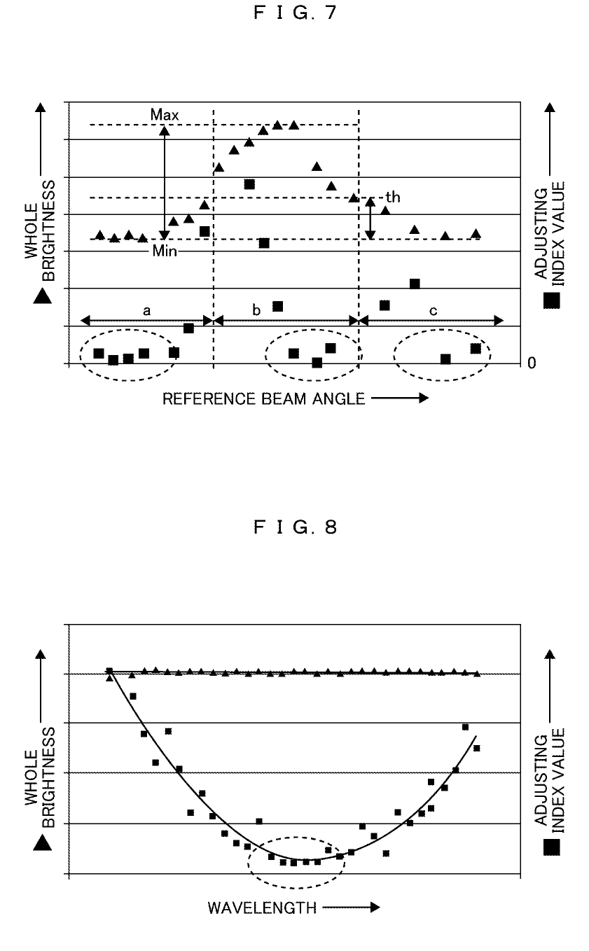

FIG. 7 is a graph plotting the relation on a certain wavelength between the reference beam angle, the whole brightness and the adjusting index value along the line 1 in FIG. 6(A) and FIG. 6(B), and the processing corresponds to steps S103 to S106 in FIG. 5. The triangle black marks represent the whole brightness while the square black marks represent the adjusting index values, wherein the adjusting index values become low in each of a high region (b) and low regions (a, c) with respect to the whole brightness (i.e., portions encircled by broken-line circles). Although it is necessary to seek a point where the adjusting index value becomes minimum, the index value becomes low also in the regions where the whole brightness is low like this, and thus, it becomes necessary to distinguish these regions. Therefore, in the present embodiment, it is designed to detect the minimum value of the adjusting indexes in the region being high in whole brightness. More specifically, it is designed to detect a measuring point at which the adjusting index value becomes minimum, in the region b where the whole brightness becomes higher than a threshold value. That is, the threshold value th is calculated by the following expression (2).

th=(Max−Min)×k+Min (2)

Here, Max represents the maximum value in brightness, Min represents the minimum value in brightness, and k represents a coefficient.

FIG. 8 shows adjusting index values on the line 2 which are obtained by repeating the detection along the line 1 in FIG. 6(A) and FIG. 6(B) on respective wavelengths. That is, FIG. 8 is a graph plotting the relation between the wavelength and the minimum adjusting index value with changes of the reference beam angle. In FIG. 8, the minimum value of the adjusting index values becomes the adjusting index value calculated finally (i.e., the portion encircled by a broken-line circle). That is, this processing corresponds to that at step S107 in FIG. 5, and a reference beam angle and a wavelength that are optimum can be obtained based on the adjusting index value so calculated.

It is to be noted that each time an optical information recording medium is mounted on the optical information reproducing device, the foregoing adjustment is made before the reproduction. Further, the adjustment may be made when a large change occurs in temperature or when the reproduction data becomes illegible. In the case of the temperature change, a compensation may be made using a coefficient corresponding to the temperature.

Further, the division into the small regions is not limited to the 8×8 division described in the present embodiment.

As described hereinbefore, the present embodiment is directed to a reference beam adjusting method for reproducing information recorded on an optical information recording medium by utilizing interference of a signal beam with a reference beam, wherein the method includes a step of changing the wavelength of the reference beam, a step of changing the angle of the reference beam to the optical information recording medium, a step of detecting a brightness distribution of a reproduction image from the optical information recording medium, a step of calculating a gravity center dispersion in the brightness distribution of the reproduction image, and a step of controlling the angle and wavelength of the reference beam based on the gravity center dispersion.

Further, the present embodiment is directed to a reference beam reproducing device for reproducing information recorded on an optical information recording medium by utilizing interference of a signal beam with a reference beam, wherein the device includes a light source that emits a beam toward the optical information recording medium, a light source control unit that controls the wavelength of the beam emitted from the light source, a reference beam angle control unit that controls the incidence angle of the reference beam on the optical information recording medium, a light detector that detects a brightness distribution of a reproduction image from the optical information recording medium, a reproduction image processing unit that calculates a gravity center dispersion in the brightness distribution of the reproduction image, and a control unit that controls the angle and wavelength of the reference beam based on the gravity center dispersion.

Therefore, according to the present embodiment, it is possible to provide an adjusting index which is used for speedily adjusting the incidence angle of the reference beam and the wavelength of the right source and which is difficult to be influenced by the unevenness in brightness and the like at the bright line portion, and thereby to provide an optical information reproducing device and a reference beam adjusting method capable of adjusting the angle and wavelength of the reference beam.

### Second Embodiment

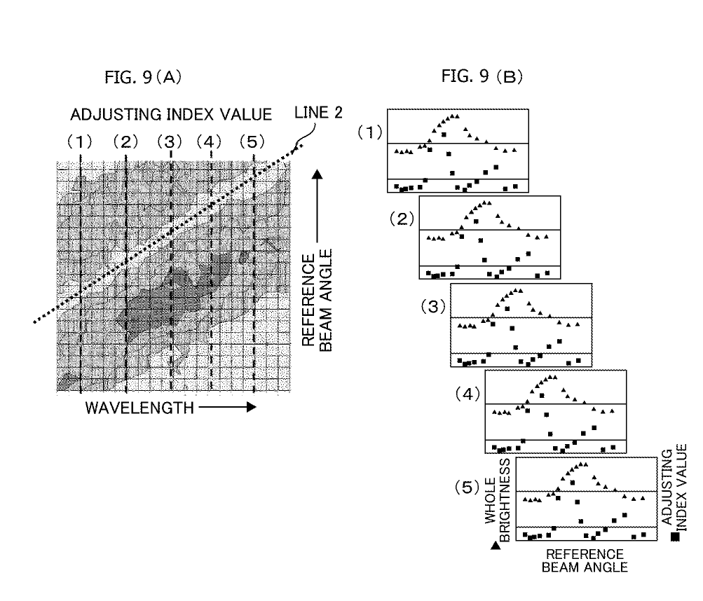

In the first embodiment, in order to obtain adjusting index values on the line 2 as shown in FIG. 9(A), it is necessary to take measurements on the line 1 in FIG. 6(A) and FIG. 6(B) with changes of the reference beam angle in connection with chances of the wavelength through a number of times, as shown in FIG. 9(B). However, the results of such measurements in low brightness regions are unnecessary, as mentioned previously. Therefore, in the present embodiment, description will be made regarding a method capable of shortening the time taken for adjustment by decreasing unnecessary measurements.

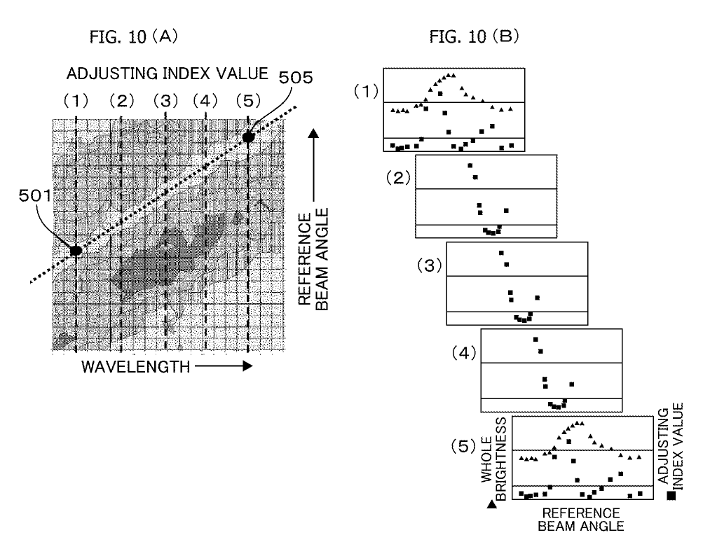

In this method, first of all, there is sought a straight line passing through two points (501, 505) shown in FIG. 10(A). These two points (501, 505) can be obtained by specifying adjusting index minimum values which are detected on respective wavelengths (1) and (5) shown in FIG. 10(A) in connection with changes of the reference beam angle. Since the line 2 to be sought finally is anticipated to reside around or in the neighborhood of this straight line, measurements on remaining wavelengths (2) to (4) are directed to those within a narrow reference beam angle range the center of which is at an intersection point with the line 2, and by these measurements within the narrow beam angle range, it becomes possible to obtain the adjusting index minimum values on respective wavelengths. That is, at the two points respectively on a short wavelength and a long wavelength within a wavelength changing range, the adjusting index values are taken with changes of the reference beam angle to the full as shown at (1) and (5) in FIG. 10(B), and the two points (501, 505) in FIG. 10(A) are obtained based on the reference beam angles determining the respective minimum adjusting index values. Then, the measurements on the remaining wavelengths (2) to (4) in FIG. 10(A) are carried out within the reference beam angle range narrowed by the two points 501 and 505 and only in the neighborhood of the straight line passing through the two points 501 and 505.

Therefore, according to the present embodiment, it is possible to anticipate the reference beam angle range within which the adjusting index values to be sought can be obtained, and hence, to decreases the number of times for the measurements.

### Third Embodiment

There are some case where a surface reflection from an optical information recording medium adversely affects a brightness distribution of a production image on the light detector. A solution in such cases will be described hereinafter.

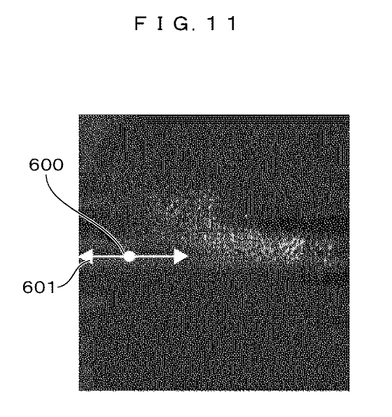

FIG. 11 shows a brightness distribution of a reproduction image on the light detector, and as exemplified therein, a case arises wherein a surface reflection 600 from the optical information recording medium appears like an actual brightness distribution. Further, this surface reflection shifts its position as indicated at 601 in FIG. 11 in dependence on the reference beam angle. Therefore, in order to improve the adjusting index in accuracy, it is necessary to provide means for removing the affection caused by the surface reflection.

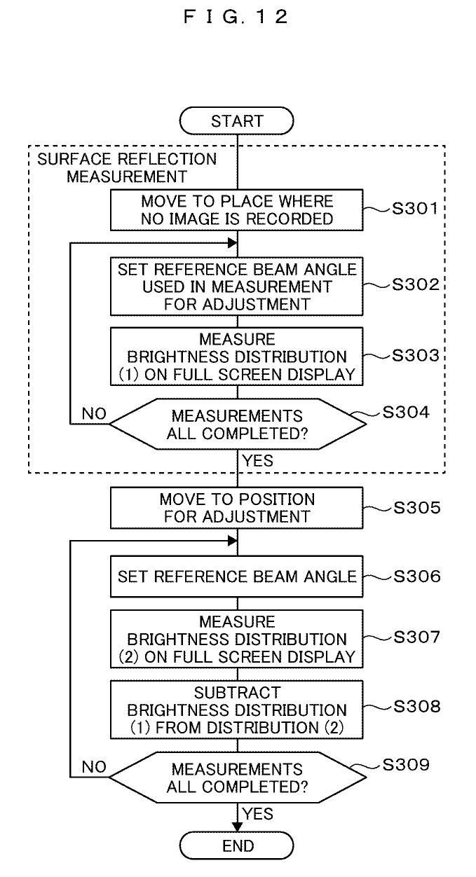

To this end, as shown in FIG. 12, it is executed to measure a brightness distribution of the surface reflection only in advance of adjustments of the reference beam angle and the wavelength, and then, to subtract such a brightness distribution of the surface reflection only from those distributions obtained at the time of measurements for adjustment. Specifically, at S301, a movement is made to a position where no imaged is recorded, and at S302 through S304, the brightness distribution on the full screen is measured in connection with changes of the reference beam angle used at the time of measurements for adjustment. Then, at S305, a movement is made to a position for adjustment, and through S306 and S307, a brightness distribution for adjustment is measured. Then, at S308, the brightness distribution obtained at S303 and attributed to the surface reflection is subtracted from the brightness distribution measured for adjustment, so that the affection caused by the surface reflection can be obviated.

The present invention is not limited to the foregoing embodiments and can cover various modifications as well. Further, the foregoing embodiments have been described in detail for the purpose of describing the present invention in an easy-to-understand manner and therefore, the present invention is not necessarily limited to what is provided with all of the components described earlier. Further, it is possible to replace a part of constructions in one of the embodiments by a part of constructions in another embodiment, and it is also possible to add the construction in another embodiment to the construction in one of the embodiments. Moreover, it is possible to make an addition of another construction, a deletion or a replacement with respect to a part of the construction in each embodiment.

Obviously, numerous other modifications and variations of the Present invention are possible in light of the above teachings. It is therefore to be understood that within the scope of the appended claims, the present invention may be practiced otherwise than as specifically described herein.

What is claimed is:

1. A reference beam adjusting method for reproducing information recorded on an optical information recording medium by utilizing interference of a signal beam with a reference beam, the method comprising the steps of:
changing the wavelength of the reference beam;
changing the angle of the reference beam to the optical information recording medium;
detecting a brightness distribution of a reproduction image from the optical information recording medium;
calculating a gravity center dispersion in the brightness distribution of the reproduction image; and
controlling the angle and wavelength of the reference beam based on the gravity center dispersion.

2. The reference beam adjusting method according to claim 1, wherein the brightness distribution of the reproduction image has a bright line being a linear portion being high in brightness when a pitch direction angle being the angle in a direction approximately normal to the reference beam angle is shifted.

3. The reference beam adjusting method according to claim 2, wherein the step of calculating the gravity center dispersion in the brightness distribution includes:
dividing the reproduction image into a plurality of small regions in an X-direction and a Y-direction orthogonal to the X-direction;
calculating gravity centers in brightness distributions of respective X-direction elements within each line region in the Y-direction; and
calculating a dispersion of the gravity centers in the Y-Y direction.

4. The reference beam adjusting method according to claim 3, further comprising:
setting a designated wavelength by the step of changing the wavelength;
changing the reference beam angle to a plurality of angles by the step of changing the angle of the reference beam;
detecting respective brightness distributions of the reproduction image corresponding to the plurality of angles by the step of detecting the brightness distribution;
determining a combination between the reference beam angle and the wavelength in which combination the dispersion in the Y-direction of the respective brightness distributions of the reproduction image becomes a minimum value, by the step of calculating the gravity center dispersion in the brightness distribution; and
changing the wavelength by the step of changing the wavelength to seek combinations between the reference beam angle and the wavelength in which combinations the dispersions become minimum values, respectively on the changed wavelengths and then to determine, from the combinations between the reference beam angle and the wavelength sought respectively on the changed wavelengths in which combinations the dispersions become minimum values, a combination between the reference beam angle and the wavelength in which combination the dispersion becomes the minimum value.

4. reference beam adjusting method according to claim 4, wherein
the step of calculating the gravity center dispersion in the brightness distribution includes determining combinations between the reference beam angle and the wavelength in which combinations the dispersions in the Y-direction of the respective brightness distributions of the reproduction image become minimum values, the respective brightness distributions being equal to or higher than a designated brightness and corresponding to the plurality of angles.

6. The reference beam adjusting method according to claim 4, wherein:
the step of changing the wavelength by the step of changing the wavelength to seek combinations between the reference beam angle and the wavelength in which combinations the dispersions become minimum values, respectively on the changed wavelengths is executed on two wavelengths;
a reference beam angle range is anticipated from the combinations, sought on the two wavelengths, between the reference beam angle and the wavelength in which combinations the respective dispersions become minimum values, to decrease the number of times through which the reference beam angle is changed in connection with changes to other wavelengths; and
a combination between the reference beam angle and the wavelength in which combination the dispersion becomes the minimum value is determined within the combinations between the reference beam angle and the wavelength in which combinations the dispersions respectively sought on the changed wavelengths become minimum values.

7. The reference beam adjusting method according to claim 1, wherein the step of detecting the brightness distribution of the reproduction image from the optical information recording medium includes:
measuring a brightness distribution of a surface reflection from the optical information recording medium in advance of controlling the reference beam angle and the wavelength; and
subtracting the brightness distribution of the surface reflection from the brightness distribution of the reproduction image.

8. A reference beam reproducing device for reproducing information recorded on an optical information recording medium by utilizing interference of a signal beam with a reference beam, the device comprising:
a light source that emits a beam toward the optical information recording medium;
a light source control unit that controls the wavelength of the beam emitted from the light source;
a reference beam angle control unit that controls an incidence angle of the reference beam on the optical information recording medium;
a light detector that detects a brightness distribution of a reproduction image from the optical information recording medium;
a reproduction image processing unit that calculates a gravity center dispersion in the brightness distribution of the reproduction image; and
a control unit that controls the angle and wavelength of the reference beam based on the gravity center dispersion.
